(19) United States
(12) Patent Application Publication
(10) Pub. No.: US 2026/0155301 A1
(43) Pub. Date: Jun. 4, 2026

(54) MULTILAYER CERAMIC CAPACITOR

(71) Applicant: Murata Manufacturing Co., Ltd., Nagaokakyo-shi (JP)

(72) Inventor: Shoji FUKUI, Nagaokakyo-shi (JP)

(73) Assignee: Murata Manufacturing Co., Ltd., Nagaokakyo-shi (JP)

(21) Appl. No.: 19/405,457

(22) Filed: Dec. 2, 2025

(30) Foreign Application Priority Data
Dec. 4, 2024 (JP) 2024-211708

(51) Int. Cl. H01G 4/008; H01G 4/012; H01G 4/12; H01G 4/30

(52) U.S. Cl. CPC H01G 4/008; H01G 4/012; H01G 4/1227; H01G 4/30

(57) ABSTRACT

To provide a multilayer ceramic capacitor having high overall reliability, a multilayer bod includes laminated dielectric layers and inner electrode layers. A first main-surface segregation layer is between the inner electrode layer closest to the first main surface and a first outer dielectric layer. A second main-surface segregation layer is between the inner electrode layer closest to the second main surface and a second outer dielectric layer. A first side-surface segregation layer and a second side-surface segregation layer are located at end portions of the plurality of inner electrode layers on respective sides in the width direction. Each of the main-surface and side-surface segregation layers contains a group of specific elements including one or more elements selected from the group consisting of rare-earth elements, Si, and homologous elements of Si.

### CROSS-REFERENCE TO RELATED APPLICATION

This application claims the benefit of priority to Japanese Patent Application No. 2024-211708, filed on Dec. 4, 2024. The disclosure of this application is incorporated by reference herein in its entirety.

### BACKGROUND

### 1. Field

The present disclosure relates to multilayer ceramic capacitors.

### 2. Description of the Related Art

A configuration of a multilayer ceramic electronic component having side margins at side surfaces is known. Japanese Unexamined Patent Application Publication No. 2023-163437 describes a multilayer ceramic electronic component having a configuration in which silicon, boron, or the like is segregated in the side margins to increase the reliability.

### SUMMARY

In terms of reliability, weak points are not only the side margins. The end portions of inner electrodes aligned at the side surfaces of a multilayer body also have weak points which can cause problems. In Japanese Unexamined Patent Application Publication No. 2023-163437, dielectric green sheets and inner electrode patterns are alternately laminated to form a multilayer portion. Then, dielectric sheets are attached to respective side surfaces of the multilayer portion to form side margins.

However, in such a method of manufacturing, since the end portions of the inner electrodes having different polarities are close to one another, manufacturing defects tend to occur. In addition, moisture resistance through the dielectric layers located on the main surfaces cannot be ensured.

From the above situation, the disclosure is directed to providing a multilayer ceramic capacitor having high overall reliability.

To achieve the above-mentioned object, a multilayer ceramic capacitor according to the present invention includes a multilayer body. The multilayer body includes a plurality of dielectric layers and a plurality of inner electrode layers, which are laminated together. The multilayer body includes a first main surface and a second main surface opposed to each other in a lamination direction, a first side surface and a second side surface opposed to each other in a width direction orthogonal to the lamination direction, and a first end surface and a second end surface opposed to each other in a longitudinal direction orthogonal to the lamination direction and the width direction. Outer electrodes each electrically coupled to at least one of the plurality of inner electrode layers are located to cover at least part of the first end surface and at least part of the second end surface. A first outer dielectric layer is located to cover a first main surface side of a first main-surface inner electrode layer which is one of the plurality of inner electrode layers closest to the first main surface. A second outer dielectric layer is located to cover a second main surface side of a second main-surface inner electrode layer which is one of the plurality of inner electrode layers closest to the second main surface. A first main-surface segregation layer is located between the first main-surface inner electrode layer and the first outer dielectric layer. A second main-surface segregation layer is located between the second main-surface inner electrode layer and the second outer dielectric layer. A first side-surface segregation layer and a second side-surface segregation layer are located at end portions of the plurality of inner electrode layers on respective sides in the width direction. Each of the first main-surface segregation layer, the second main-surface segregation layer, the first side-surface segregation layer, and the second side-surface segregation layer contains a group of specific elements including one or more elements selected from the group consisting of rare-earth elements, Si, and homologous elements of Si.

Since the present disclosure has a configuration including the first main-surface segregation layer, the second main-surface segregation layer, the first side-surface segregation layer and the second side-surface segregation layer, it is possible to achieve a multilayer ceramic capacitor with high overall reliability.

### BRIEF DESCRIPTION OF THE DRAWINGS

FIG. 1 is a perspective view of a multilayer ceramic capacitor according to Embodiment 1 of the present disclosure;

FIG. 2 is a perspective view of an element body portion included in the multilayer ceramic capacitor according to Embodiment 1 of the present disclosure;

FIG. 3 is an exploded perspective view of the element body portion included in the multilayer ceramic capacitor according to Embodiment 1 of the present disclosure;

FIG. 4 is a sectional view taken along line IV-IV in FIG. 1, viewed in the direction of the arrows;

FIG. 5 is a sectional view taken along line V-V in FIG. 1, viewed in the direction of the arrows;

FIG. 6 is a sectional view of the element body portion included in the multilayer ceramic capacitor according to Embodiment 1 of the present disclosure, illustrating its main portions in detail;

FIG. 7 is a sectional view of part of FIG. 6, illustrating further details; and

FIG. 8 is an enlarged sectional view of a portion at which a first main surface is in contact with a second end surface and the vicinity of the portion in the multilayer ceramic capacitor according to Embodiment 1 of the present disclosure.

### DETAILED DESCRIPTION

In the drawings, the ratios of dimensions are not necessarily consistent with the actual ones and are sometimes exaggerated for the convenience of explanation. In the following description, references to the concepts of “upper” and “lower” do not necessarily mean absolute upper or lower, but mean relative upper and lower in the illustrated posture in some cases.

In the figures referred to in the following description, L represents the longitudinal direction of an element body portion described later; W, the width direction of the element body portion; and T, the thickness direction of the element body portion.

### Embodiment 1

### Configuration

A multilayer ceramic capacitor according to Embodiment 1 of the present disclosure will be described with reference to FIGS. 1 to 5.

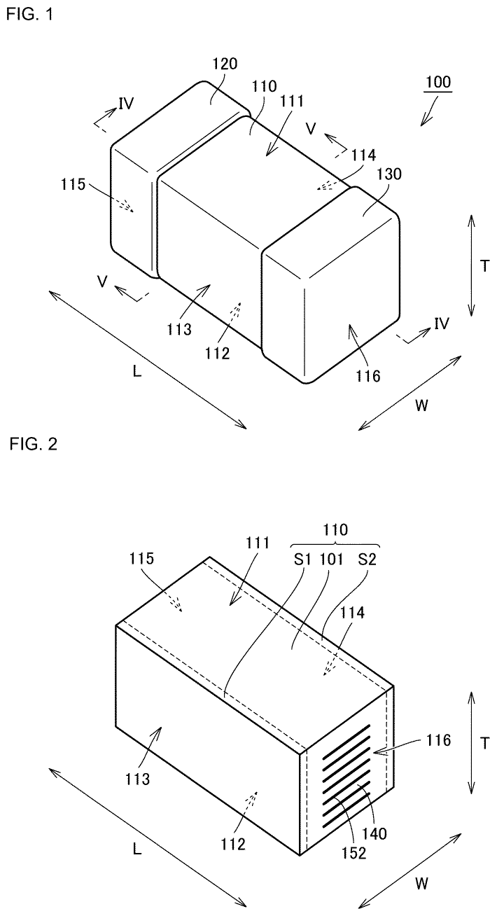

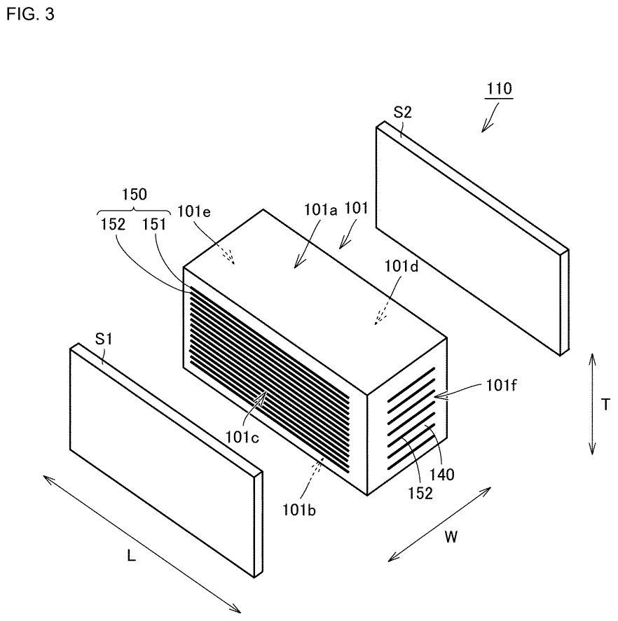

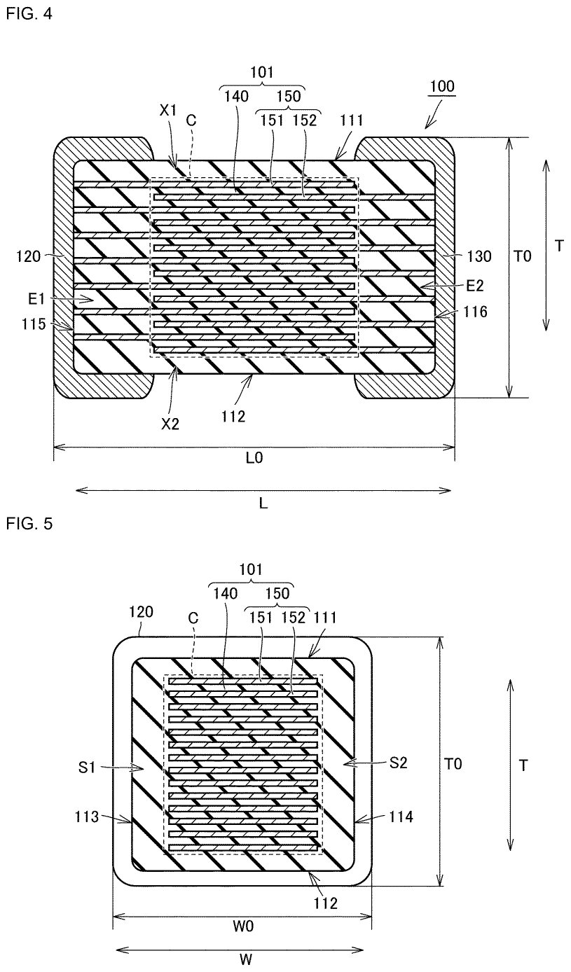

FIG. 1 illustrates the outer appearance of a multilayer ceramic capacitor 100 according to the present embodiment. FIG. 2 illustrates an element body portion 110 which is part of the multilayer ceramic capacitor 100. FIG. 3 is an exploded perspective view of the element body portion 110, for schematically illustrating its configuration. FIG. 4 is a sectional view taken along line IV-IV in FIG. 1, viewed in the direction of the arrows. FIG. 5 is a sectional view taken along line V-V in FIG. 1, viewed in the direction of the arrows.

As illustrated in FIG. 1, the multilayer ceramic capacitor 100 includes the element body portion 110 and outer electrodes. The multilayer ceramic capacitor 100 includes a first outer electrode 120 and a second outer electrode 130 as the outer electrodes.

As illustrated in FIG. 1, the element body portion 110 has an approximately rectangular parallelepiped shape. As illustrated in FIGS. 1 and 2, the element body portion 110 has a first main surface 111 and a second main surface 112 opposed to each other in the thickness direction T, a first side surface 113 and a second side surface 114 opposed to each other in the width direction W which intersects the thickness direction T, and a first end surface 115 and a second end surface 116 opposed to each other in the longitudinal direction L which intersects the thickness direction T and the width direction W.

The element body portion 110 may have rounded vertex portions and rounded ridge line portions. A vertex portion means a portion at which three surfaces of the element body portion 110 intersect, and a ridge line portion means a portion at which two surfaces of the element body portion 110 intersect.

As illustrated in FIGS. 1 and 4, the first outer electrode 120 is located at the first end surface 115. Specifically, the first outer electrode 120 is formed on the entire first end surface 115 and also extends to turn from the first end surface 115 onto the first main surface 111, the second main surface 112, the first side surface 113, and the second side surface 114.

As illustrated in FIGS. 1 and 4, the second outer electrode 130 is located at the second end surface 116. Specifically, the second outer electrode 130 is formed on the entire second end surface 116 and also extends to turn from the second end surface 116 onto the first main surface 111, the second main surface 112, the first side surface 113, and the second side surface 114.

As illustrated in FIGS. 2 and 3, the element body portion 110 includes a multilayer body 101, a first side margin portion S1, and a second side margin portion S2.

As illustrated in FIG. 3, the multilayer body 101 includes a pair of main surfaces 101a and 101b opposed to each other in the thickness direction T, a pair of side surfaces 101c and 101d opposed to each other in the width direction, and a pair of end surfaces 101e and 101f opposed to each other in the longitudinal direction. The pair of main surfaces 101a and 101b serve as parts of the first main surface 111 and the second main surface 112 of the element body portion 110, respectively. The side surface 101c is covered with the first side margin portion S1, and the side surface 101d is covered with the second side margin portion S2. The pair of end surfaces 101e and 101f serve as parts of the first end surface 115 and the second end surface 116 of the element body portion 110, respectively.

As illustrated in FIGS. 3 to 5, the multilayer body 101 includes a plurality of dielectric layers 140 and a plurality of inner electrode layers 150 alternately laminated in the thickness direction T. The plurality of inner electrode layers 150 includes a plurality of first inner electrode layers 151 and a plurality of second inner electrode layers 152. The plurality of first inner electrode layers 151 and the plurality of second inner electrode layers 152 are alternately laminated in the thickness direction T.

The plurality of first inner electrode layers 151 are extended to the first end surface 115. The plurality of first inner electrode layers 151 are coupled to the first outer electrode 120. The plurality of second inner electrode layers 152 are extended to the second end surface 116. The plurality of second inner electrode layers 152 are coupled to the second outer electrode 130. The end portions of the plurality of first inner electrode layers 151 and the plurality of second inner electrode layers 152 on respective sides in the width direction W are exposed to the side surfaces 101c and 101d.

Although FIGS. 3 to 5 are based on an example including seven first inner electrode layers 151 and seven second inner electrode layers 152, the number of the first inner electrode layers 151 and the number of the second inner electrode layers 152 are not limited to seven.

The plurality of dielectric layers 140 include outer-layer dielectric portions and inner-layer dielectric portions. The outer-layer dielectric portions are located between the first main surface 111 and the inner electrode layer 150 closest to the first main surface 111 in the thickness direction T and between the second main surface 112 and the inner electrode layer 150 closest to the second main surface 112 in the thickness direction T. The inner-layer dielectric portions are each located between two inner electrode layers 150 adjacent to each other in the thickness direction T.

The number of the dielectric layers 140 may be 100 or more and 1000 or less. Each of the dielectric layers 140 is composed of, for example, a dielectric ceramic material containing BaTiO₃. The dielectric layers 140 may contain an additive component whose content is less than that of the main component. The additive component may be, for example, a Mn compound, an Fe compound, a Cr compound, a Co compound, a Ni compound, or the like. The thickness of each dielectric layer may be 0.4 μm or more and 0.45 μm or less.

The first inner electrode layers 151 and the second inner electrode layers 152 contain Ni as the main component. The first inner electrode layers 151 and the second inner electrode layers 152 may further contain a dielectric material having the same compositional system as that used in the ceramic contained in the dielectric layers 140. In addition, the first inner electrode layers 151 and the second inner electrode layers 152 may contain Sn or the like at the interfaces with the dielectric layers 140.

As illustrated in FIG. 4, the multilayer body 101 is divided into an inner-layer portion C, a first outer-layer portion X1 and a second outer-layer portion X2, and a first end-margin portion E1 and a second end-margin portion E2. The inner-layer portion C includes parts of the first inner electrode layers 151 and parts of the second inner electrode layers 152 laminated together in the thickness direction T, and this structure generates an electrostatic capacity.

The first outer-layer portion X1 and the second outer-layer portion X2 are located on respective sides of the inner-layer portion C in the thickness direction T. The first outer-layer portion X1 is located outside and adjacent to the inner-layer portion C in the thickness direction T on the first main surface 111 side. The second outer-layer portion X2 is located outside and adjacent to the inner-layer portion C in the thickness direction T on the second main surface 112 side.

The first outer-layer portion X1 and the second outer-layer portion X2 are the outer-layer dielectric portions. The first outer-layer portion X1 and the second outer-layer portion X2 may be composed of the same dielectric ceramic material as that used in the plurality of dielectric layers 140 or a dielectric ceramic material different from that used in the plurality of dielectric layers 140.

The first end-margin portion E1 and the second end-margin portion E2 are located on respective sides of the inner-layer portion C in the longitudinal direction L. The first end-margin portion E1 is located outside and adjacent to the inner-layer portion C in the longitudinal direction L on the first end surface 115 side. The second end-margin portion E2 is located outside and adjacent to the inner-layer portion C in the longitudinal direction L on the second end surface 116 side.

The side margin portions are located between the first side surface 113 and the plurality of inner electrode layers 150 and between the second side surface 114 and the plurality of inner electrode layers 150 in the width direction W in the element body portion 110. The side margin portions include the first side margin portion S1 and the second side margin portion S2.

The first side margin portion S1 is located on the side surface 101c of the multilayer body 101. The first side margin portion S1 covers the entire side surface 101c. The first side margin portion S1 is present in the region of the element body portion 110 from the ends of the inner electrode layers 150 on one side in the width direction W to the first side surface 113.

The second side margin portion S2 is located on the side surface 101d of the multilayer body 101. The second side margin portion S2 covers the entire side surface 101d. The second side margin portion S2 is present in the region of the element body portion 110 from the other ends of the inner electrode layers 150 on the other side in the width direction W to the second side surface 114.

The first side margin portion S1 and the second side margin portion S2 may be composed of the same dielectric ceramic material as that used in the plurality of dielectric layers 140 or a dielectric ceramic material different from that used in the plurality of dielectric layers 140.

The first side margin portion S1 and the second side margin portion S2 contain segregated Si. The segregation of Si can be confirmed by observing a cross section with, for example, an SEM-EDX.

Each of the first side margin portion S1 and the second side margin portion S2 may include a plurality of layers. The plurality of layers are not limited to ones having observable interfaces between layers.

As described above, the size of the multilayer ceramic capacitor 100 including the element body portion 110 and the first and second outer electrodes 120 and 130 is not particularly limited, and for example, the following ranges can be employed.

As illustrated in FIG. 4, the dimension (length dimension L0) of the multilayer ceramic capacitor 100 in the longitudinal direction L is, for example, 0.1 mm or more and 1.0 mm or less. The dimension (thickness dimension TO) of the multilayer ceramic capacitor 100 in the thickness direction T is, for example, 0.05 mm or more and 0.5 mm or less. As illustrated in FIG. 5, the dimension (width dimension W0) of the multilayer ceramic capacitor 100 in the width direction W is, for example, 0.05 mm or more and 0.5 mm or less. Note that the dimensions mentioned above are values excluding the tolerances. In actual situations, tolerances are added to the dimensions mentioned above.

The multilayer ceramic capacitor 100 according to the present embodiment includes the multilayer body 101. The multilayer body 101 includes the plurality of dielectric layers 140 and the plurality of inner electrode layers 150, which are laminated together. The multilayer body 101 has the first main surface 111 and the second main surface 112 opposed to each other in the lamination direction, the first side surface 113 and the second side surface 114 opposed to each other in the width direction W orthogonal to the lamination direction, and the first end surface 115 and the second end surface 116 opposed to each other in the longitudinal direction L orthogonal to the lamination direction and the width direction W. The outer electrodes each electrically coupled to at least one of the plurality of inner electrode layers 150 are located so as to cover at least part of the first end surface 115 and at least part of the second end surface 116. The “outer electrodes” mentioned above refer to the first outer electrode 120 and the second outer electrode 130.

A first outer dielectric layer 241 is located to cover the first main surface 111 side of a first main-surface inner electrode layer 150a which is the one of the plurality of inner electrode layers 150 closest to the first main surface 111. A second outer dielectric layer 242 is located to cover the second main surface 112 side of a second main-surface inner electrode layer 150b which is the one of the plurality of inner electrode layers 150 closest to the second main surface 112. A first main-surface segregation layer 211 is located between the first main-surface inner electrode layer 150a and the first outer dielectric layer 241. A second main-surface segregation layer 212 is located between the second main-surface inner electrode layer 150b and the second outer dielectric layer 242.

A first side-surface segregation layer 215 and a second side-surface segregation layer 216 are located at the end portions of the plurality of inner electrode layers 150 on respective sides in the width direction W.

Each of the first main-surface segregation layer 211, the second main-surface segregation layer 212, the first side-surface segregation layer 215, and the second side-surface segregation layer 216 contains a group of specific elements including one or more elements selected from the group consisting of the rare-earth elements, Si, and the homologous elements of Si, i.e., Group 14 elements.

### Manufacturing Method

Each segregation layer can be formed by adjusting the amounts of various compositions, the firing temperature, and the like. For example, the group of specific elements may be included in the dielectric paste or a separate paste applied to the main or side surfaces, wherein the elements migrate to form the segregation layers during the firing process.

### Outer Electrodes

The outer electrodes will be described in detail. Each outer electrode not only covers one end surface of the multilayer body 101 but also extends from the end surface to the side surfaces and the main surfaces. Each outer electrode includes an underlying electrode layer and a plating layer located on the underlying electrode layer. Each underlying electrode layer includes one or more layers selected from the group consisting of a fired layer, a resin layer, and a thin film layer. The “fired layer” mentioned above contains glass and metal. The glass contained in the fired layer contains one or more elements selected from the group consisting of Si and the homologous elements of Si. The metal contained in the fired layer contains at least one metal selected from, for example, Cu, Ni, Ag, Pd, Ag—Pd alloys, Au, and the like. Each fired layer may include a plurality of layers. The fired layers are formed by applying a conductive paste containing glass and metal on the multilayer body 101 and firing it. The fired layers may be fired simultaneously with the inner electrodes. Alternatively, the fired layers may be fired after firing the inner electrodes.

The “resin layer” mentioned above may contain conductive particles and a thermosetting resin. In the case in which resin layers are formed as at least parts of the underlying electrode layers, the resin layers may be formed directly on the surfaces of the multilayer body without forming the fired electrode layers. Each resin layer may include a plurality of layers.

The “thin film layer” mentioned above refers to a layer having a thickness of 1 μm or less and composed of deposited metal particles formed by a thin film forming method such as sputtering or vapor deposition.

The “plating layer” mentioned above contains at least one material selected from, for example, Cu, Ni, Ag, Pd, Ag—Pd alloys, Au, and the like. The plating layer may include a plurality of layers. The plating layer may have a two-layer structure including a Ni plating layer and a Sn plating layer. Ni plating layers prevent erosion of the underlying electrode layers by solder when the ceramic electronic component is mounted. Sn plating layers improve the wettability of solder when the ceramic electronic component is mounted, and this makes the mounting easy.

### Inner Electrode Layers

The plurality of inner electrode layers 150 will be described in detail. The inner electrode layers 150 contain a metal such as Ni, for example. The inner electrode layers 150 may further contain dielectric particles having the same compositional system as that used in the ceramic contained in the dielectric layers. The number of the inner electrode layers 150 may be 100 or more and 1000 or less. The thickness of each of the inner electrode layers 150 may be 0.4 μm or more and 0.45 μm or less. Each of the first inner electrode layers 151 includes a facing electrode portion that faces the second inner electrode layer 152 and an extended electrode portion that extends from the facing electrode portion to a corresponding one of the end surfaces of the multilayer body 101. Each of the second inner electrode layers 152 includes a facing electrode portion that faces the first inner electrode layer 151 and an extended electrode portion that extends from the facing electrode portion to a corresponding one of the end surfaces of the multilayer body 101. The extended electrode portions are present in both the first end-margin portion E1 and the second end-margin portion E2. Sn or the like may be present at the interfaces between the inner electrode layers 150 and the dielectric layers.

### Operation and Advantageous Effects

Since the present embodiment includes the first side-surface segregation layer 215 and the second side-surface segregation layer 216, the reliability of the end portions of the inner electrodes in the width direction is high. In addition, the present embodiment also includes the first main-surface segregation layer 211 and the second main-surface segregation layer 212; thus, the reliability in moisture resistance on the main surface sides is high. These layers can improve the overall reliability of the multilayer ceramic capacitor.

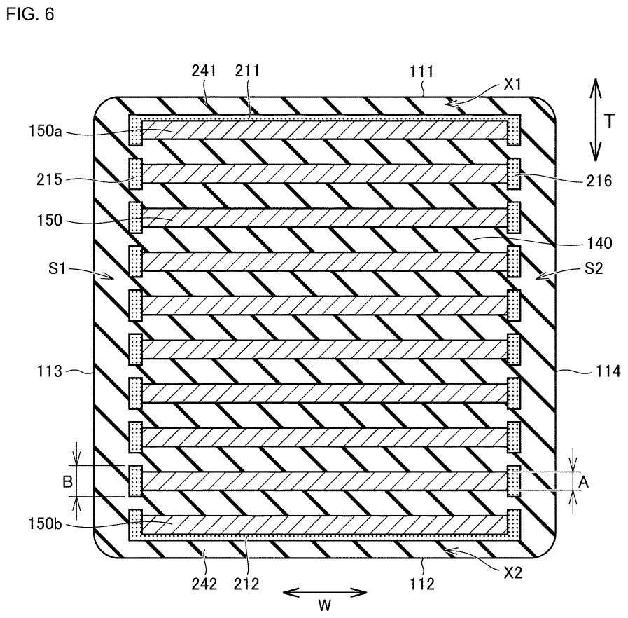

Note that FIG. 6 is a diagram illustrating the plurality of inner electrode layers 150 and their surrounding portions in detail by eliminating the first outer electrode 120 which is seen on the far side in FIG. 5.

As illustrated in FIG. 6, the dimension B in the thickness direction T of a segregation layer at an end portion of an inner electrode layer 150 in the width direction W may be larger than the thickness A of the inner electrode layer 150. This is because the relationship A<B as mentioned above can contribute to improving the reliability.

The positional deviation of the end portions of the inner electrode layers 150 in the width direction W may be 5 μm or less. Employment of this configuration can improve the reliability.

The group of specific elements mentioned above may include a first element that is Si or a homologous element of Si and a second element that is a rare-earth element, and the molar ratio of the first element to Ti may be higher than the molar ratio of the second element to Ti.

The molar ratio of the first element to Ti is may be 1.0 or more and 2.5 or less. As can be seen from the experiment results described later, employment of this configuration can prevent short-circuit defects.

The molar ratio of the second element to Ti may be 0.3 or more and 1.1 or less. As can be seen from the experiment results described later, employment of this configuration can improve the reliability.

The group of specific elements may include only Si. The group of specific elements may include one or more elements selected from the group consisting of Dy, Ho, Tb, and Y.

The thickness of each of the dielectric layers may be 0.4 μm or more and 0.45 μm or less.

Note that when discussing the thickness of each of the inner electrode layers and the dielectric layers, “the thickness” means the average thickness. The average thickness is measured as follows. First, a cross section of a multilayer body orthogonal to the longitudinal direction L, which is exposed by polishing, is observed with a scanning electron microscope. Next, the thickness is measured on a total of five lines: one center line, which is parallel to the lamination direction and passes through the center of the cross section of the multilayer body; and four lines, two on each side of the center line at equal intervals. The average value of these five measurement values is regarded as the average thickness. To obtain a more accurate average thickness, the five measurement values mentioned above are obtained in each of an upper portion, a central portion, and a lower portion in the lamination direction, and the average value of these measurement values is regarded as the average thickness.

The thickness of each of the first outer-layer portion X1 and the second outer-layer portion X2, in other words, the thickness of each of the first outer dielectric layer 241 and the second outer dielectric layer 242, may be 10 μm or more and 20 μm or less.

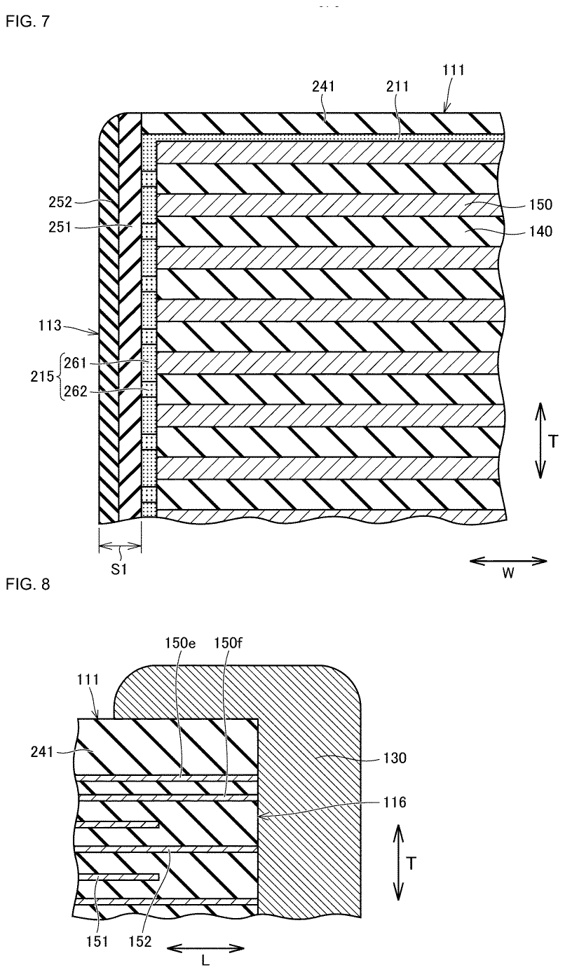

As illustrated in FIG. 7, the side margin portions may have a two-layer structure including an inner layer and an outer layer. The side margin portions are not limited to having a two-layer structure but may have a structure including three or more layers. FIG. 7 is an enlarged view of the first side margin portion S1 and its vicinity.

The segregation layer formed along the side surface, specifically, the segregation layer formed at the end portions of the inner electrode layers 150 is not limited to ones formed discontinuously in the lamination direction so as to correspond to the end portions of the inner electrode layers 150 but may be ones formed so as to fill the gaps between the inner electrode layers 150 in the lamination direction. FIG. 7 shows such an example. In this case, the first side-surface segregation layer 215 formed along the first side surface 113 may include first concentration portions 261 and second concentration portions 262. The first concentration portions 261 are formed at the positions corresponding to the end portions of the inner electrode layers 150. The first concentration portions 261 may be formed by the occurrence of segregation in which the group of specific elements segregates into the end portions of the inner electrode layers 150. Thus, parts of the inner electrode layers 150 may become the first concentration portions 261. The second concentration portions 262 are portions in which the concentration of the segregated elements is lower than that in the first concentration portions 261. Each of the second concentration portions 262 is formed to connect adjacent ones of the first concentration portions 261. The second concentration portions 262 are formed at the positions corresponding to the gaps between the inner electrode layers 150. The second concentration portions 262 may be formed in regions that are not inherently the inner electrode layers 150. The first concentration portions 261 and the second concentration portions 262 are formed alternately to be continuous in the lamination direction, in other words, in the thickness direction T. The difference between the first concentration portions 261 and the second concentration portions 262 can be detected by observing the color shade with, for example, an SEM-EDX, a WDX, or the like, so that these portions can be distinguished.

Of the plurality of inner electrode layers 150, an outermost inner electrode layer and its corresponding second outermost inner electrode layer may be coupled to the same outer electrode. This point will be explained with reference to FIG. 8. FIG. 8 is an enlarged view of a portion at which the first main surface 111 is in contact with the second end surface 116 and the vicinity of the portion. In the example illustrated in FIG. 8, the outermost inner electrode layer 150e and the second outermost inner electrode layer 150f are coupled to the second outer electrode 130 which is formed to cover the second end surface 116. In this case, the first main-surface segregation layer 211 may be formed, as a segregation layer, between the first outer dielectric layer 241 and the outermost inner electrode layer 150e of the plurality of inner electrode layers 150. In other words, the first main-surface segregation layer 211 may be formed, as a segregation layer, not in a portion outside and adjacent to the inner electrode layer 150f which is the outermost inner electrode layer of the assembly of the first inner electrode layers 151 and the second inner electrode layers 152 alternately arranged, but in a portion outside and adjacent to the inner electrode layer 150e which is away from the assembly of the first inner electrode layers 151 and the second inner electrode layers 152 alternately arranged.

Although FIG. 8 illustrates an example in which the two outermost inner electrode layers 150 are coupled to the same outer electrode, the number of the inner electrode layers 150 continuously arranged at outermost positions and coupled to the same outer electrode is not limited to two but may be three or more.

### Example of Experiment

As an experiment to confirm the reliability of the multilayer ceramic capacitor, a highly accelerated life test (HALT) was conducted. The purpose of this experiment was to check the moisture resistance reliability, and 100 specimens were prepared for each condition of Examples 1 to 7 and Comparative Examples 1 to 2. A condition of a temperature of 85° C., a humidity of 85% RH, a voltage of 6.3V, and 1000 hours was applied to the 100 specimens, and the number of specimens whose insulation resistance value became 10⁷Ω or less was counted.

Whether a short-circuit defect occurred was checked by applying a voltage of 0.5V to each of the 100 specimens. If the insulation resistance value is 3.0Ω or less, the specimen was regarded as NG (defective), and if the insulation resistance value is more than 3.0Ω, the specimen was regarded as G (good). The results are shown in the column “Short-Circuit Defect” in Table 1.

The results of the experiment are shown in Table 1.

TABLE 1

| | Molar Ratio | Molar Ratio | | |
|---|---|---|---|---|
| | of Si or | of Rare- | | |
| | Homologous | Earth | Short- | |
| | Element of | Element | Circuit | |
| Sample | Si to Ti | to Ti | Defect | Reliability |
| Comparative | 0.9 | 0.1 | NG | 13/100 |
| Example 1 | | | | |
| Example 1 | 1.0 | 0.25 | G | 2/100 |
| Example 2 | 1.2 | 0.3 | G | 0/100 |
| Example 3 | 1.5 | 0.5 | G | 0/100 |
| Example 4 | 1.7 | 0.6 | G | 0/100 |
| Example 5 | 1.9 | 0.9 | G | 0/100 |
| Example 6 | 2.2 | 1.1 | G | 0/100 |
| Example 7 | 2.5 | 1.2 | G | 3/100 |
| Comparative | 2.6 | 1.3 | NG | 16/100 |
| Example 2 | | | | |

As can be seen in Table 1, the results of short-circuit defect show that Comparative Examples 1 and 2 were NG and that Examples 1 to 7 were G. Regarding the reliability, the ratio of NG was made significantly low in Examples 1 to 7, compared with that in Comparative Examples 1 and 2. From the results of this experiment, it was confirmed that the present disclosure can reduce short-circuit defects and, at the same time, improve the reliability.

Note that some of the aforementioned embodiments can be combined for use as appropriate. Note that the aforementioned disclosed embodiments are mere examples in every respect and are not restrictive. The scope of the present invention is defined by the claims and includes all modifications within the scope of the claims and the equivalents thereof.

What is claimed is:

1. A multilayer ceramic capacitor comprising
a multilayer body, wherein
the multilayer body includes a plurality of dielectric layers and a plurality of inner electrode layers, which are laminated together,
the multilayer body includes a first main surface and a second main surface opposed to each other in a lamination direction, a first side surface and a second side surface opposed to each other in a width direction orthogonal to the lamination direction, and a first end surface and a second end surface opposed to each other in a longitudinal direction orthogonal to the lamination direction and the width direction,
a first outer electrode and a second outer electrode that cover at least part of the first end surface and at least part of the second end surface, respectively, wherein the first and second outer electrodes are each electrically coupled to at least one of the plurality of inner electrode layers;
a first outer dielectric layer is located to cover a first main surface side of a first main-surface inner electrode layer which is one of the plurality of inner electrode layers closest to the first main surface,
a second outer dielectric layer is located to cover a second main surface side of a second main-surface inner electrode layer which is one of the plurality of inner electrode layers closest to the second main surface,
a first main-surface segregation layer is located between the first main-surface inner electrode layer and the first outer dielectric layer,
a second main-surface segregation layer is located between the second main-surface inner electrode layer and the second outer dielectric layer,
a first side-surface segregation layer and a second side-surface segregation layer are located at width direction end portions of the plurality of inner electrode layers on respective sides in the width direction, and
each of the first main-surface segregation layer, the second main-surface segregation layer, the first side-surface segregation layer, and the second side-surface segregation layer contains a group of specific elements including one or more elements selected from the group consisting of rare-earth elements, Si, and homologous elements of Si.

2. The multilayer ceramic capacitor according to claim 1, wherein
a positional deviation of the end portions of the plurality of inner electrode layers in the width direction is 5 μm or less.

3. The multilayer ceramic capacitor according to claim 1, wherein
the group of specific elements includes a first element that is Si or a homologous element of Si and a second element that is a rare-earth element, and
a molar ratio of the first element to Ti is higher than a molar ratio of the second element to Ti.

4. The multilayer ceramic capacitor according to claim 3, wherein
the molar ratio of the first element to Ti is 1.0 or more and 2.5 or less.

5. The multilayer ceramic capacitor according to claim 3, wherein
the molar ratio of the second element to Ti is 0.3 or more and 1.1 or less.

6. The multilayer ceramic capacitor according to claim 1, wherein
the group of specific elements includes only Si.

7. The multilayer ceramic capacitor according to claim 1, wherein
the group of specific elements includes one or more elements selected from the group consisting of Dy, Ho, Tb, and Y.

8. The multilayer ceramic capacitor according to claim 1, wherein
a thickness of each of the plurality of dielectric layers is 0.4 μm or more and 0.45 μm or less.

9. The multilayer ceramic capacitor according to claim 1, wherein a dimension in the lamination direction of the first or second side-surface segregation layer at an end portion of one of the inner electrode layers is larger than a thickness of the one of the inner electrode layers.

10. The multilayer ceramic capacitor according to claim 1, wherein the first side-surface segregation layer is continuous in the lamination direction and includes:
a plurality of first concentration portions located at positions corresponding to the width-direction end portions of the inner electrode layers; and
a plurality of second concentration portions located at positions corresponding to gaps between the inner electrode layers, wherein the first concentration portions have a higher concentration of the group of specific elements than the second concentration portions.

11. The multilayer ceramic capacitor according to claim 1, wherein an outermost inner electrode layer and a second outermost inner electrode layer of the plurality of inner electrode layers, adjacent to the first main surface, are both electrically coupled to one of the outer electrodes.

12. The multilayer ceramic capacitor according to claim 1, wherein the outer electrodes each include an underlying electrode layer and a plating layer located on the underlying electrode layer.

13. The multilayer ceramic capacitor according to claim 12, wherein the underlying electrode layer includes a fired layer containing glass and metal.

14. The multilayer ceramic capacitor according to claim 12, wherein the plating layer includes a Ni plating layer and a Sn plating layer.

15. The multilayer ceramic capacitor according to claim 1, wherein the plurality of inner electrode layers contain Ni as a main component.

16. The multilayer ceramic capacitor according to claim 1, wherein the plurality of dielectric layers contain BaTiO3 as a main component.

17. The multilayer ceramic capacitor according to claim 1, wherein a thickness of each of the first outer dielectric layer and the second outer dielectric layer is 10 μm or more and 20 μm or less.

18. The multilayer ceramic capacitor according to claim 1, wherein the plurality of inner electrode layers includes an alternating stack of first inner electrode layers and second inner electrode layers, the first main-surface inner electrode layer is an outermost inner electrode layer located between the first outer dielectric layer and the alternating stack, and the outermost inner electrode layer and a second outermost inner electrode layer, the second outermost inner electrode layer being part of the alternating stack, are both electrically coupled to a same outer electrode.

19. A multilayer ceramic capacitor comprising:
a multilayer body having a plurality of dielectric layers containing Titanium (Ti) and a plurality of inner electrode layers;
at least one segregation layer located adjacent to at least one of a main surface or a width-direction end portion of the plurality of inner electrode layers;
wherein the at least one segregation layer contains a first element that is Si or a homologous element of Si and a second element that is a rare-earth element;
wherein a molar ratio of the first element to Ti is 1.0 or more and 2.5 or less; and
wherein a molar ratio of the second element to Ti is 0.3 or more and 1.1 or less.

20. A multilayer ceramic capacitor, comprising:
a multilayer body including a plurality of dielectric layers and a plurality of inner electrode layers laminated in a lamination direction, the inner electrode layers having width-direction end portions; and
a side-surface segregation layer located at the width-direction end portions of the plurality of inner electrode layers;
wherein the side-surface segregation layer is continuous in the lamination direction and includes:
a plurality of first concentration portions located at positions corresponding to the width-direction end portions; and
a plurality of second concentration portions located at positions corresponding to gaps between the inner electrode layers in the lamination direction,
wherein the first concentration portions have a higher concentration of a group of specific elements than the second concentration portions, the group of specific elements including one or more elements selected from the group consisting of rare-earth elements, Si, and a homologous element of Si.
